(19) United States
(12) Patent Application Publication
(10) Pub. No.: US 2012/0239396 A1
(43) Pub. Date: Sep. 20, 2012

(54) MULTIMODAL REMOTE CONTROL

(75) Inventors: Michael James Johnston, New York, NY (US); Marcelo Worsley, Stanford, CA (US)

(73) Assignee: AT&T INTELLECTUAL PROPERTY I, L.P., Atlanta, GA (US)

(21) Appl. No.: 13/048,669

(22) Filed: Mar. 15, 2011

(51) Int. Cl. G10L 15/26; G10L 21/00

(52) U.S. Cl. 704/235; 704/275; 704/E15.043; 704/E21.001

(57) ABSTRACT

A method and system for operating a remotely controlled device may use multimodal remote control commands that include a gesture command and a speech command. The gesture command may be interpreted from a gesture performed by a user, while the speech command may be interpreted from speech utterances made by the user. The gesture and speech utterances may be simultaneously received by the remotely controlled device in response to displaying a user interface configured to receive multimodal commands.

### FIELD OF THE DISCLOSURE

The present disclosure relates to remote control and, more particularly, to multimodal remote control to operate a device.

### BACKGROUND

Remote controls provide convenient operation of equipment from a distance. Many consumer electronic devices are equipped with a variety of remote control features. Implementing numerous features on a remote control may result in a complex and inconvenient user interface.

### BRIEF DESCRIPTION OF THE DRAWINGS

FIG. 1 is a block diagram of selected elements of an embodiment of a multimodal remote control system;

FIG. 2 illustrates an embodiment of a method for performing multimodal remote control;

FIG. 3 illustrates another embodiment of a method for performing multimodal remote control; and

FIG. 4 is a block diagram of selected elements of an embodiment of a remotely controlled device.

### DETAILED DESCRIPTION

In one aspect, a disclosed remote control method includes detecting an audio input including speech content from a user and detecting a motion input representative of a gesture performed by the user. The method may further include performing speech-to-text conversion on the audio input to generate a speech command and processing the motion input to generate a gesture command. The method may also include synchronizing the speech command and the gesture command to generate a multimodal command.

In certain embodiments, the method may further include executing the multimodal command, including displaying multimedia content specified by the multimodal command. The multimedia content may be a television program. The method operation of detecting the motion input may include receiving an infrared (IR) signal generated by a remote control. The motion input may be indicative of movement of a source of an infrared signal. The method operation of detecting the motion input may include receiving images depicting body movements of the user. The method operations of detecting the motion input and detecting the audio input may occur in response to displaying a user interface configured to accept the multimodal command.

In another aspect, a remotely controlled device for processing multimodal commands includes a processor configured to access memory media, an IR receiver, and a microphone. The memory media may include instructions to capture a speech utterance from a user via the microphone, and capture a gesture performed by the user via the IR receiver. The memory media may also include instructions to identify a speech command from the speech utterance, identify a gesture command from the gesture, and combine the speech command and the gesture command into a multimodal command.

In particular embodiments, the memory media may include instructions to capture the gesture by detecting a motion of an IR source. The memory media may also include instructions to execute the multimodal command, including outputting multimedia content associated with the multimodal command.

In various embodiments, the memory media may include executable instructions to display, using a display device, a user interface configured to accept the multimodal command. The remotely controlled device may further include a display device configured to display the multimedia content. The remotely controlled device may further include an image sensor, while the memory media may include instructions to capture, using the image sensor, the gesture by detecting a body motion of the user.

In a further aspect, a disclosed computer-readable memory media includes executable instructions for receiving multimodal remote control commands. The instructions may be executable to capture, via an audio input device, a speech utterance from a user, capture, via a motion detection device, a gesture performed by the user, and identify a multimodal command based on a combination of the speech utterance and the gesture.

In certain embodiments, the memory media may include instructions to execute the multimodal command to display multimedia content specified by the multimodal command. The multimodal command may be associated with a user interface configured to accept multimodal commands. The memory media may further include instructions to perform speech-to-text conversion on the speech utterance. The motion detection device may include an IR camera. The gesture may be captured by detecting a motion of an IR source included in a remote control. The gesture may be captured by detecting a motion of the user's body.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Remote controls are widely used with various types of display systems. As larger screen displays become more prevalent and include increasing levels of digital interaction, user interaction with large screen systems may become difficult or frustrating using conventional remote controls. Since many large screen displays represent entertainment systems, such as televisions (TV) or gaming systems, accessing a full keyboard and mouse input system may not be desirable or convenient. This may preclude using typing and mouse navigation to issue search requests and navigate a user interface. A traditional remote control may provide limited navigation capabilities, such as a cluster of directional buttons (e.g., up, down, left, right), that may constrain direct manipulation of user interface elements. Other approaches utilizing gloves and/or colored markers that the user wears can be cumbersome and may limit widespread application of the resulting technology.

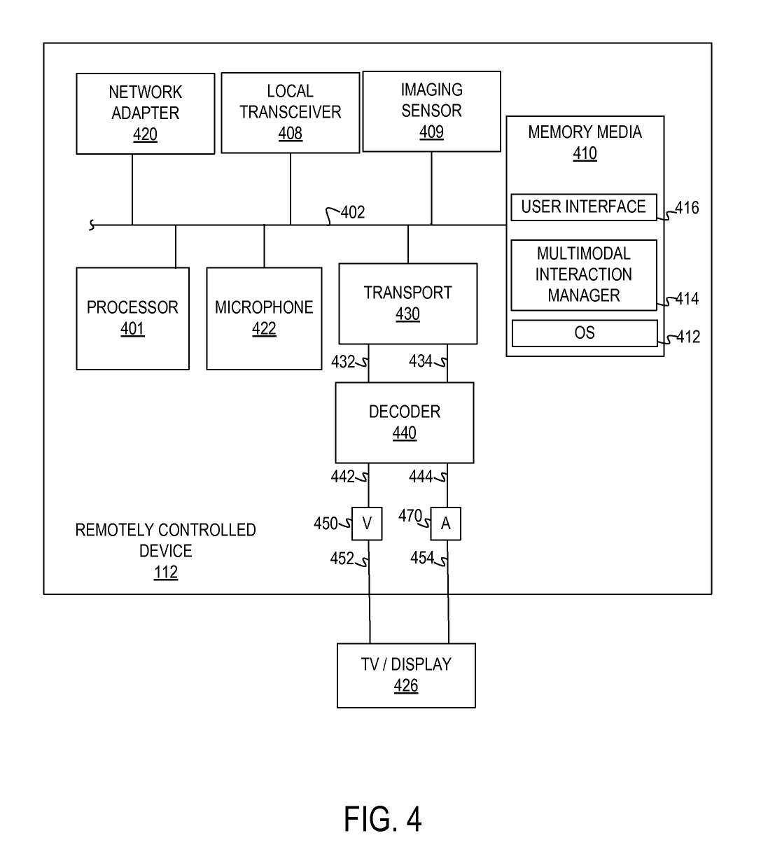

According to the methods presented herein, the user may make gestures using a conventional remote control, or another device, that serves as an IR source. The location and/or motion of the IR source may be detected using an IR sensor. In addition, the user's speech may be captured using an audio input device and may be processed using speech-to-text conversion. A processing element, for example a multimodal interaction manager (see also FIG. 4), may receive signals resulting from recognition of the speech and capture of the remote control movements. The signals may be integrated (i.e., synchronized and/or combined) to determine a multimodal command that the user is trying to send. Multimodal remote control methods, as described herein, may represent an improvement over traditional remote controls and may be well suited for controlling large screen display systems. For example, users may directly point at a specific item on a display that they are interested in and may utilize a deictic reference (e.g., “play this”) in order to select or activate that item. Multimodal remote control methods may further enable users to make gestures such as circling, swiping, and crossing out user interface elements shown on the display.

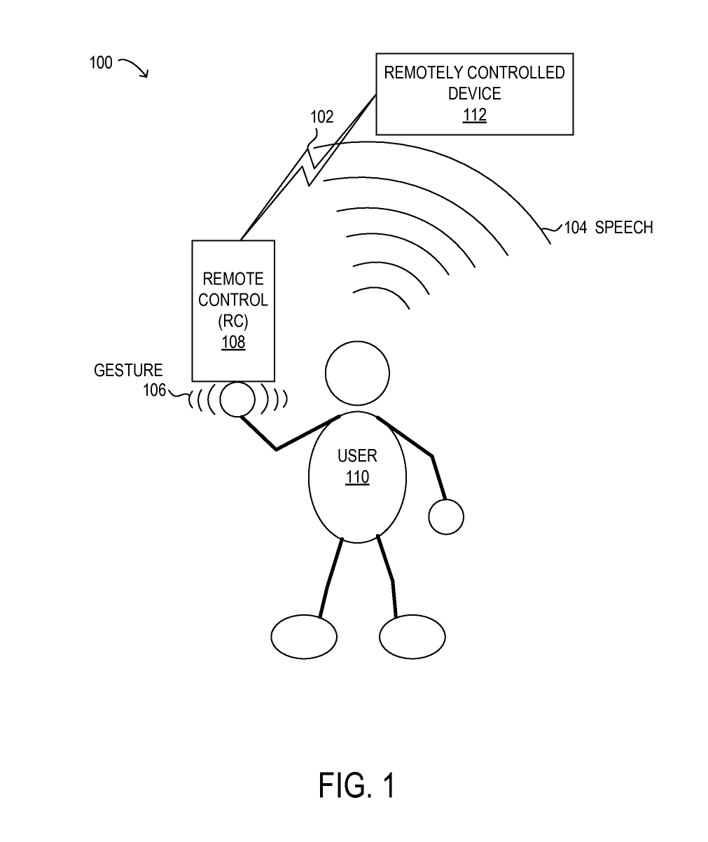

Referring now to FIG. 1, a block diagram of selected elements of an embodiment of multimodal remote control system 100 is depicted. As used herein, “multimodal” refers to information provided by at least two independent pathways. For example, a multimodal remote control command may include a gesture command and a voice command that may be synchronized or combined to generate (or specify) the multimodal remote control command. As used herein, a “gesture” or “gesture motion” refers to a particular motion, or sequences of motions performed by a user. The gesture motion may be a translation or a rotation, or a combination thereof, in 2- or 3-dimensional space. Specific gesture motions may be defined and assigned to predetermined remote control commands, which may be referred to as a “gesture command”.

In FIG. 1, multimodal remote control system 100 illustrates devices, interfaces and information that may be processed to enable user 110 to control remotely controlled device 112 in a multimodal manner. In system 100, remotely controlled device 112 may represent any of a number of different types of devices that may be remotely controlled, such as media players, TVs, or client-premises equipment (CPE) for multimedia content distribution networks (MCDNs), among others. Remote control (RC) 108 may represent a device configured to wirelessly send commands to remotely controlled device 112 via wireless interface 102. Wireless interface 102 may be a radio-frequency interface or an IR interface. RC 108 may be configured to send remote control commands in response to operation of control elements (i.e., buttons or other elements, not shown in FIG. 1) included in RC 108 by user 110.

In addition to receiving such remote control commands from RC 108, remotely controlled device 112 may be configured to detect a motion of RC 108, for example, by detecting a motion of an IR source (not shown in FIG. 1) included in RC 108. In this manner, when user 110 holds RC 108 and performs gesture 106, a corresponding gesture command may be registered by remotely controlled device 112. It is noted that in this manner, gesture 106 may be performed using an instance of RC 108 that is not necessarily configured to communicate explicitly with remotely controlled device 112, but nonetheless includes an IR source (not shown in FIG. 1) that may be used to generate a motion that is registered as a gesture command by remotely controlled device 112. It is also noted that other types of signal sources, including other types of IR sources, may be substituted for RC 108 in various embodiments.

In other embodiments, gesture 106 may be performed by user 110 in the absence of RC 108 (not shown in FIG. 1). Remotely controlled device 112 may be configured with an imaging sensor that can detect body motion of user 110 associated with gesture 106. The body motion associated with gesture 106 may be associated with one or more body parts of user 110, such as a head, torso, limbs, shoulders, hips, etc. Gesture 106 may result in a corresponding gesture command that is detected by remotely controlled device 112.

In addition to gesture 106, user 110 may speak out commands at remotely controlled device 112 resulting in speech 104. The speech utterances generated by user 110 may be received and interpreted by remotely controlled device 112, which may be equipped with an audio input device (not shown in FIG. 1). In various embodiments, remotely controlled device 112 may perform a speech-to-text conversion on audio signals received from user 110 to generate (or identify) speech commands. A range of different speech commands may be recognized by remotely controlled device 112.

In operation, multimodal remote control system 100 may present a user interface (not shown in FIG. 1) at remotely controlled device 112 that is configured to accept multimodal commands. The user interface may include various menu options, selectable items, and/or guided instructions, etc. User 110 may navigate the user interface by performing gesture 106 and/or speech 104. Certain combinations of gesture 106 and speech 104 may be interpreted by remotely controlled device 112 as a multimodal remote control command. The multimodal command may depend on a context within the user interface.

As described herein, multimodal remote control system 100 may enable a more natural and effective interaction with systems in the home, classroom, workplace and elsewhere using multimodal remote control commands that comprise combinations of speech and gesture input. For example, user 110 may desire to perform a media search, and may gesture at remotely controlled device 112 using RC 108 to active a search feature while speaking a phrase specifying certain search terms, such as “find me action movies with Angelina Jolie.” Multimodal remote control system 100 may identify a multimodal command to search for multimedia content listings, and then display a number of search results pertaining to “action movies” and “Angelina Jolie”, for example on a display device (not shown in FIG. 1) configured for operation with remotely controlled device 112. User 110 may then point using RC 108, as if it were a ‘magic wand’, to specify one of a series of displayed search results, while uttering the phrase “record this one”. Multimodal remote control system 100 may identify a multimodal command to record the specified item in the search results and then initiate a recording thereof.

In another example, user 110 may desire to interact with a map-based user interface and may gesture to a map item (e.g., icon, application, URL, etc.) and utter the term “San Francisco Calif.”. Multimodal remote control system 100 may identify a multimodal command to open a mapping application and display mapping information for San Francisco, such as an actual satellite image and/or an aerial map of San Francisco. User 110 may then gesture to circle an area on the displayed map/image using RC 108 while speaking out the phrase “zoom in here”. Multimodal remote control system 100 may then recognize a multimodal command to zoom the displayed map/image and may then zoom the display to show a higher resolution centered at the selected area.

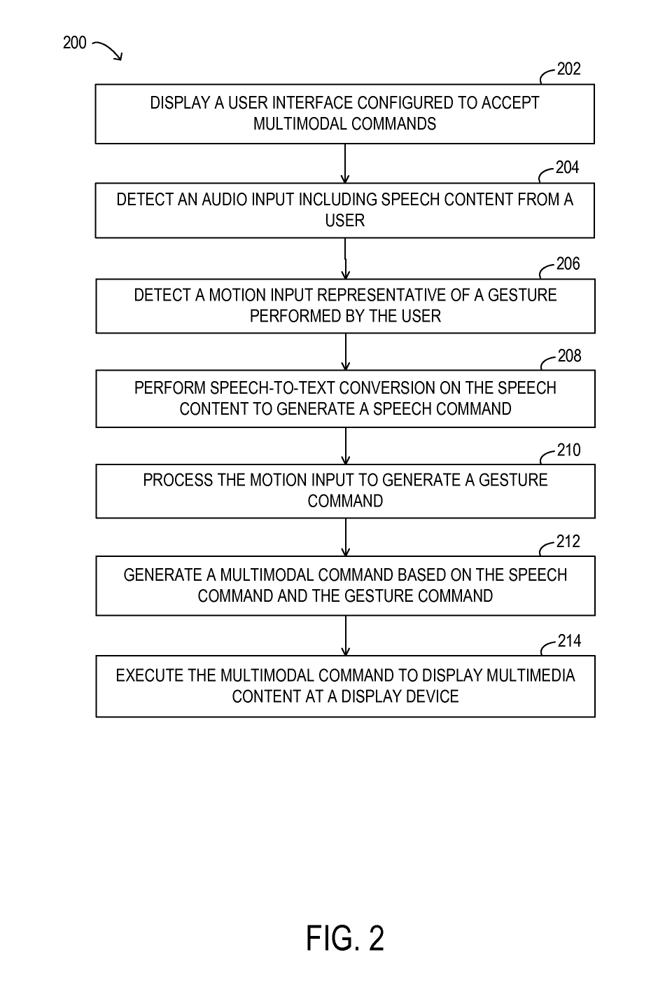

Turning now to FIG. 2, an embodiment of method 200 for multimodal remote control is illustrated. In one embodiment, method 200 is performed by remotely controlled device 112 (see FIG. 1). It is noted that certain operations described in method 200 may be optional or may be rearranged in different embodiments.

Method 200 may begin by displaying (operation 202) a user interface configured to accept multimodal commands. The multimodal commands accepted by the user interface may comprise a set of speech commands and a set of gesture commands. The speech commands and the gesture commands may be individually paired to specify a set of multimodal commands. In one example, the user interface may be included in an electronic programming guide for selecting multimedia programs, such as TV programs, for viewing. The user interface may be an operational control interface for any of a number of large screen display devices, as mentioned previously. Next, an audio input may be detected (operation 204) including speech content from a user. The audio input may represent speech utterances from the user. A motion input may be detected (operation 206) and may be representative of a gesture performed by the user. In various embodiments, the audio input in operation 204 and the motion input in operation 206 are received simultaneously (i.e., in parallel). In certain embodiments, the motion input may be detected by tracking a motion of an IR source that is manipulated according to the gesture by the user. In other embodiments, the motion input may be detected by tracking a motion of the user's body. It is noted that the gesture may include more than one motion input, or may specify more than one input value. For example, a user may select an origin and a destination by gesturing at two locations on a displayed map. In another example, a user may select multiple items in a multimedia programming guide using multiple gestures.

Method 200 may continue by performing (operation 208) speech-to-text conversion on the speech content to generate a speech command. In operation 206, the speech content (or the resulting converted text output) may be compared to a set of valid speech commands to determine a best matching speech command. The motion input may be processed (operation 210) to generate a gesture command. In operation 208, the motion input may be compared to a set of gesture commands to determine a best matching gesture command. A multimodal command may be generated (operation 212) based on the speech command and the gesture command. Generating the multimodal command in operation 212 may involve matching a combination of the speech command and the gesture command to a known multimodal command. The multimodal command may be executed (operation 214) to display multimedia content at a display device. Displaying multimedia content may include navigating the user interface, searching multimedia content, modifying displayed multimedia content, and outputting multimedia programs, among other display actions. The multimedia content may be specified by the multimodal command.

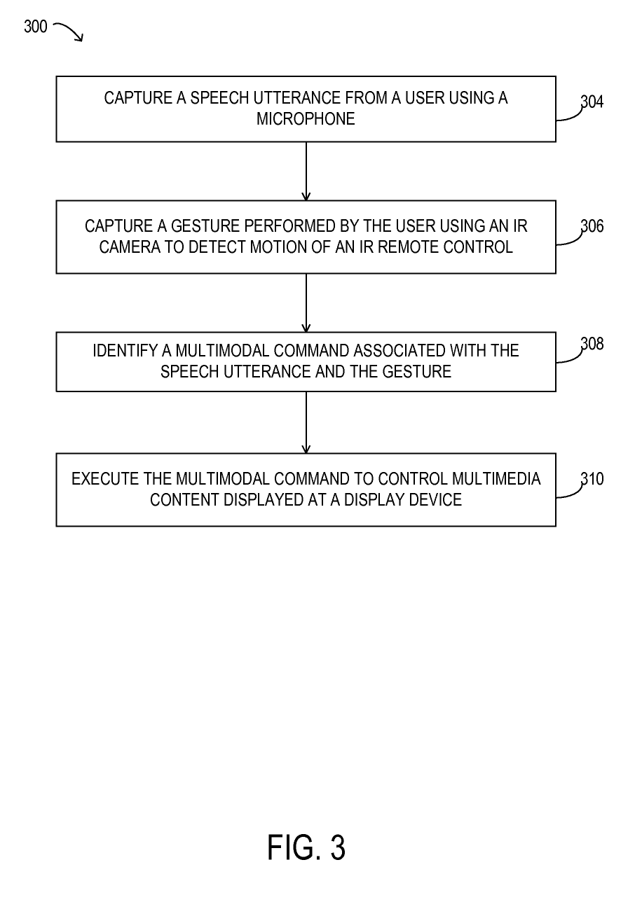

Turning now to FIG. 3, an embodiment of method 300 for multimodal remote control is illustrated. In one embodiment, method 300 is performed by remotely controlled device 112 (see FIG. 1). It is noted that certain operations described in method 300 may be optional or may be rearranged in different embodiments.

Method 300 may begin by capturing (operation 304) a speech utterance from a user using a microphone. The microphone may be coupled to and/or integrated with remotely controlled device 112 (see also FIG. 4). A gesture performed by the user may be captured (operation 306) using an IR camera to detect motion of an IR remote control. The IR camera may be coupled to and/or integrated with remotely controlled device 112 (see also FIG. 4). It is noted that additional sensors or multiple instances of an IR camera may be used in operation 306, for example, to capture 3-dimensional (or multiple 2-dimensional) motions. A multimodal command may be identified (operation 308) that is based on (associated with) the speech utterance and the gesture. The multimodal command may be executed (operation 310) to control content displayed at a display device.

Referring now to FIG. 4, a block diagram illustrating selected elements of an embodiment of remotely controlled device 112 is presented. As noted previously, remotely controlled device 112 may represent any of a number of different types of devices that are remote-controlled, such as media players, TVs, or CPE for MCDNs, such as U-Verse by AT&T, among others. In FIG. 4, remotely controlled device 112 is shown as a functional component along with display 426, independent of any physical implementation, and may be any combination of elements of remotely controlled device 112 and display 426.

In the embodiment depicted in FIG. 4, remotely controlled device 112 includes processor 401 coupled via shared bus 402 to storage media collectively identified as storage 410. Remotely controlled device 112, as depicted in FIG. 4, further includes network adapter 420 that may interface remotely controlled device 112 to a local area network (LAN) through which remotely controlled device 112 may receive and send multimedia content (not shown in FIG. 4). Network adapter 420 may further enable connectivity to a wide area network (WAN) for receiving and sending multimedia content via an access network (not shown in FIG. 4).

In embodiments suitable for use in Internet protocol (IP) based content delivery networks, remotely controlled device 112, as depicted in FIG. 4, may include transport unit 430 that assembles the payloads from a sequence or set of network packets into a stream of multimedia content. In coaxial based access networks, content may be delivered as a stream that is not packet based and it may not be necessary in these embodiments to include transport unit 430. In a co-axial implementation, however, tuning resources (not explicitly depicted in FIG. 4) may be required to “filter” desired content from other content that is delivered over the coaxial medium simultaneously and these tuners may be provided in remotely controlled device 112. The stream of multimedia content received by transport unit 430 may include audio information and video information and transport unit 430 may parse or segregate the two to generate video stream 432 and audio stream 434 as shown.

Video and audio streams 432 and 434, as output from transport unit 430, may include audio or video information that is compressed, encrypted, or both. A decoder unit 440 is shown as receiving video and audio streams 432 and 434 and generating native format video and audio streams 442 and 444. Decoder 440 may employ any of various widely distributed video decoding algorithms including any of the Motion Pictures Expert Group (MPEG) standards, or Windows Media Video (WMV) standards including WMV 9, which has been standardized as Video Codec-1 (VC-1) by the Society of Motion Picture and Television Engineers. Similarly decoder 440 may employ any of various audio decoding algorithms including Dolby® Digital, Digital Theatre System (DTS) Coherent Acoustics, and Windows Media Audio (WMA).

The native format video and audio streams 442 and 444 as shown in FIG. 4 may be processed by encoders/digital-to-analog converters (encoders/DACs) 450 and 470 respectively to produce analog video and audio signals 452 and 454 in a format compliant with display 426, which itself may not be a part of remotely controlled device 112. Display 426 may comply with National Television System Committee (NTSC), Phase Alternate Line (PAL) or any other suitable television standard.

Memory media 410 encompasses persistent and volatile media, fixed and removable media, and magnetic and semiconductor media. Memory media 410 is operable to store instructions, data, or both. Memory media 410 as shown may include sets or sequences of instructions, namely, an operating system 412, a multimodal remote control application program identified as multimodal interaction manager 414, and user interface 416. Operating system 412 may be a UNIX or UNIX-like operating system, a Windows® family operating system, or another suitable operating system. In some embodiments, memory media 410 is configured to store and execute instructions provided as services by an application server via the WAN (not shown in FIG. 4).

User interface 416 may represent a guide to multimedia content available for viewing using remotely controlled device 112. User interface 416 may include a plurality of menu items arranged according to one or more menu layouts, which enable a user to operate remotely controlled device 112. The user may operate user interface 416 using RC 108 (see FIG. 1) to provide gesture commands and by making speech utterances to provide speech commands, in conjunction with multimodal interaction manager 414.

Local transceiver 408 represents an interface of remotely controlled device 112 for communicating with external devices, such as RC 108 (see FIG. 1), or another remote control device. Local transceiver 408 may also include an IR receiver, or an array of IR sensors, for detecting a motion of an IR source, such as RC 108. Local transceiver 408 may further provide a mechanical interface for coupling to an external device, such as a plug, socket, or other proximal adapter. In some cases, local transceiver 408 is a wireless transceiver, configured to send and receive IR or radio frequency or other signals. Local transceiver 408 may be accessed by multimodal interaction manager 414 for providing remote control functionality.

Imaging sensor 409 represents a sensor for capturing images usable for multimodal remote control commands. Imaging sensor 409 may provide sensitivity in one or more light wavelength ranges, including IR, visible, ultra-violet, etc. Imaging sensor 409 may include multiple individual sensors that can track 2-dimensional or 3-dimensional motion, such as a motion of a light source or a motion of a user's body. In some embodiments, imaging sensor 409 includes a camera. Imaging sensor 409 may be accessed by multimodal interaction manager 414 for providing remote control functionality. It is noted that in certain embodiments of remotely controlled device 112, imaging sensor 409 may be optional.

Microphone 422 represents an audio input device for capturing audio signals, such as speech utterances provided by a user. Microphone 422 may be accessed by multimodal interaction manager 414 for providing remote control functionality. In particular, multimodal interaction manager 414 may be configured to perform speech-to-text processing with audio signals captured by microphone 422.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A remote control method, comprising:
detecting an audio input including speech content from a user;
detecting a motion input representative of a gesture performed by the user;
performing speech-to-text conversion on the audio input to generate a speech command;
processing the motion input to generate a gesture command;
synchronizing the speech command and the gesture command to generate a multimodal command; and
executing the multimodal command at a processor.

2. The method of claim 1, further comprising displaying multimedia content specified by the multimodal command.

3. The method of claim 2, wherein the multimedia content is a television program.

4. The method of claim 1, wherein the detecting of the motion input includes receiving an infrared signal generated by a remote control.

5. The method of claim 1, wherein the motion input is indicative of movement of a source of an infrared signal.

6. The method of claim 1, wherein the motion input is representative of multiple gestures.

7. The method of claim 1, wherein the detecting of the motion input and the detecting of the audio input occur in response to displaying a user interface configured to accept the multimodal command.

8. A remotely controlled device for processing multimodal remote control commands, comprising:
a processor configured to access memory media;
an infrared receiver; and
a microphone;
wherein the memory media include instructions executable by the processor to:
capture a speech utterance from a user via the microphone;
capture a gesture performed by the user via the infrared receiver;
identify a speech command from the speech utterance;
identify a gesture command from the gesture; and
combine the speech command and the gesture command into a multimodal command.

9. The remotely controlled device of claim 8, wherein the memory media include instructions executable by the processor to capture the gesture by detecting a motion of an infrared source.

10. The remotely controlled device of claim 8, wherein the memory media include instructions executable by the processor to execute the multimodal command and output multimedia content associated with the multimodal command.

11. The remotely controlled device of claim 10, wherein the memory media include instructions executable by the processor to display, using a display device, a user interface configured to accept the multimodal command.

12. The remotely controlled device of claim 10, further comprising a display device configured to display the multimedia content.

13. The remotely controlled device of claim 8, further comprising:
an image sensor, wherein the memory media include instructions executable by the processor to capture, using the image sensor, the gesture by detecting a body motion of the user.

14. Computer-readable memory media, including instructions executable by a processor to:
capture, via an audio input device, a speech utterance from a user;
capture, via a motion detection device, a gesture performed by the user; and
identify a multimodal command based on a combination of the speech utterance and the gesture.

15. The memory media of claim 14, further comprising instructions executable by a processor to display multimedia content specified by the multimodal command.

16. The memory media of claim 14, wherein the multimodal command is associated with a user interface configured to accept multimodal commands.

17. The memory media of claim 14, further comprising instructions executable by a processor to perform speech-to-text conversion on the speech utterance.

18. The memory media of claim 14, wherein the motion detection device includes an infrared camera.

19. The memory media of claim 18, wherein the gesture is captured by detecting a motion of an infrared source included in a remote control.

20. The memory media of claim 18, wherein the gesture is captured by detecting a motion of the user.
